(19) United States
(12) Patent Application Publication
(10) Pub. No.: US 2003/0190090 A1
(43) Pub. Date: Oct. 9, 2003

(54) System and method for digital-image enhancement

(76) Inventors: Edward S. Beeman, Windsor, CO (US); Michelle R. Lehmeier, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/119,872

(22) Filed: Apr. 9, 2002

(51) Int. Cl. G06K 9/36

(52) U.S. Cl. 382/284

(57) ABSTRACT

Systems and methods are provided for enhancing related digital images through a user-friendly interactive-interview process. A digital-image-processing system may be implemented with a user interface, a data manager, and an image processor. The user interface identifies a flawed region of a first digital image and a substitute region. The image processor is configured to generate a composite image comprising the first digital image and the substitute region wherein the image processor is responsive to an interactive interview process. A digital-image processing method includes receiving related digital-image information, identifying an undesirable feature within the digital-image information, associating a desired feature within the digital-image information with the undesirable feature, replacing the undesirable feature with the desirable feature, and adjusting the image information responsible for generating the desirable feature to produce a modified digital image.

### TECHNICAL FIELD

The present invention generally relates to digital-image processing and, more particularly, to a system and method for manipulating related digital images.

### BACKGROUND

Digital-image processing has become a significant form of image (e.g., photograph, x-ray, video, etc.) processing because of continuing improvements in techniques and the increasing power of hardware devices. Digital-image processing techniques have augmented and, in some cases, replaced methods used by photographers in image composition and dark-room processing. Moreover, digitized images may be manipulated with the aid of a computer to achieve a variety of effects such as changing the shapes and colors of objects and forming composite images.

Until recently, real-time editing of digital images was feasible only on expensive, high-performance computer workstations with dedicated, special-purpose, hardware. The progress of integrated-circuit technology in recent years has produced microprocessors with significantly improved processing power and reduced the cost of computer memories. These developments have made it feasible to implement advanced graphic-editing techniques in personal computers.

Software is commercially available with a graphical-user interface (GUI) for selecting and editing a digitally generated image in a number of ways. For example, to “cut” or delete a portion of the image, the user can use a mouse to select an area of the image by clicking the left mouse button while the screen “cursor” is located on a corner of the image that is desired to be deleted, dragging the screen “cursor” with the mouse to another corner, thereby outlining a portion or all of the image. Some other image editors permit an operator to enter multiple points defining a selection polygon having greater than four sides.

Regardless, of the shape of the selected region, once the user has defined the selection region, the user then completes the “cut” by either selecting the “cut” command from a drop-down menu (using his mouse and/or a keyboard), or alternatively, by using his mouse to select and activate a graphical-interface “cut” button or icon. In either case, known image-editing software is invoked which performs the “cut” operation, resulting in the original image being replaced by an edited image which has a blanked-out area enclosed by the boundaries of the region so selected.

Some image-editing software applications permit the user to select a substitute region either from another portion of the original image or from some other image to insert over the blanked-out area in the modified image. Although the original image may be edited by inserting or overlaying image data over the blanked-out area, information inherent in the substituted region often will vary significantly from information in the original image surrounding the blanked-out area. A number of image-editing techniques permit the edited image to be improved such that the modified image appears as if it were acquired all at the same time. These editing techniques, however, are typically complex, not readily intuitive to novice users, and/or require a high degree of familiarity with the underlying image editor, image-processing techniques, and/or artistic expertise beyond that of ordinary personal-computer users.

### SUMMARY

Systems and methods for manipulating related digital images through a user-friendly interactive interview process are invented and disclosed.

Some embodiments describe a digital-image-processing system that includes a user interface, an input device, an image-data manager, an image processor, and an output device. The image-data manager, user interface, and image processor work in concert under the direction of a user of the digital-imaging system to transform a substitute region identified as having a more desirable feature or object than a region from an original digital image. The user interface contains logic designed to perform the interactive interview process to facilitate successful image editing.

Some embodiments of the image acquisition and enhancement system may be construed as providing methods for improving digital-image editing. An exemplar method includes the steps of: (1) acquiring a digital image; (2) identifying an undesirable feature region in the image; (3) identifying a desirable feature region; (4) replacing the undesirable feature region with the desirable feature region; and (5) modifying the desirable feature region to produce an acceptable modified-digital image.

### BRIEF DESCRIPTION OF THE DRAWINGS

The invention can be better understood with reference to the following drawings. The components in the drawings are not necessarily to scale. Emphasis instead is placed upon clearly illustrating the principles of the present invention. Moreover, in the drawings, like reference numerals designate corresponding parts throughout the several views.

FIG. 1 is a schematic illustrating an embodiment of an image acquisition and editing system.

FIG. 2 is a functional-block diagram illustrating an embodiment of the general-purpose computing device of FIG. 1.

FIG. 3 is a functional-block diagram of an embodiment of an image enhancer operable on the general-purpose computing device of FIG. 2.

FIG. 4 is a flow chart illustrating a method for enhanced digital-image processing that may use the image enhancer of FIG. 3.

FIGS. 5A & 5B are schematic diagrams illustrating unmodified digital images.

FIG. 6 is a schematic diagram of a modified digital image generated with the image enhancer of FIG. 3.

### DETAILED DESCRIPTION

A digital-image-processing system is disclosed. The image-processing system includes a user interface, an input device, an image-data manager, an image editor, and an output device. The image-data manager, user interface, and image processor work in concert under the direction of a user of the image-processing system to transform a substitute region identified as having a more desirable feature or object than a region from an original digital image. The user interface contains logic designed to perform an interactive-interview process to facilitate successful image editing.

The interview process is directed to acquiring information regarding an operator's perception of differences between a region in a baseline image containing an undesirable feature and a substitute region that is selected for insertion in the baseline image and responding accordingly. If subsequent observation by the user of a modified substitution region indicates an undesired result, the interview process is repeated and/or modified as indicated by the user's responses over the course of an editing session. This methodology facilitates complex-editing operations, such as selecting several portions of an original image and producing new images or a new composite image from one or more related images.

The logic is configured to probe the operator for information useful in identifying image parameters that generate a substitute region that for one reason or another is perceptively different from the surrounding base image. The logic may use various criteria to determine appropriate questions to present to the operator based on both previous responses, as well as image statistics derived from an analysis of the surrounding regions of the base image. Some embodiments present both the last-generation image and the next-generation modified image in a format that facilitates comparison by an operator of the system.

The improved digital-image-processing system is particularly adapted for “touching-up” digital images derived from photographs. While the examples that follow illustrate this particular embodiment, it should be appreciated that the improved digital imaging processing system is not limited to photograph editors alone. For example, the improved digital imaging processing system may be configured to manipulate maps, medical images, digital video images, etc. Furthermore, the improved digital-image-processing system may be integrated directly with various image acquisition and processing devices.

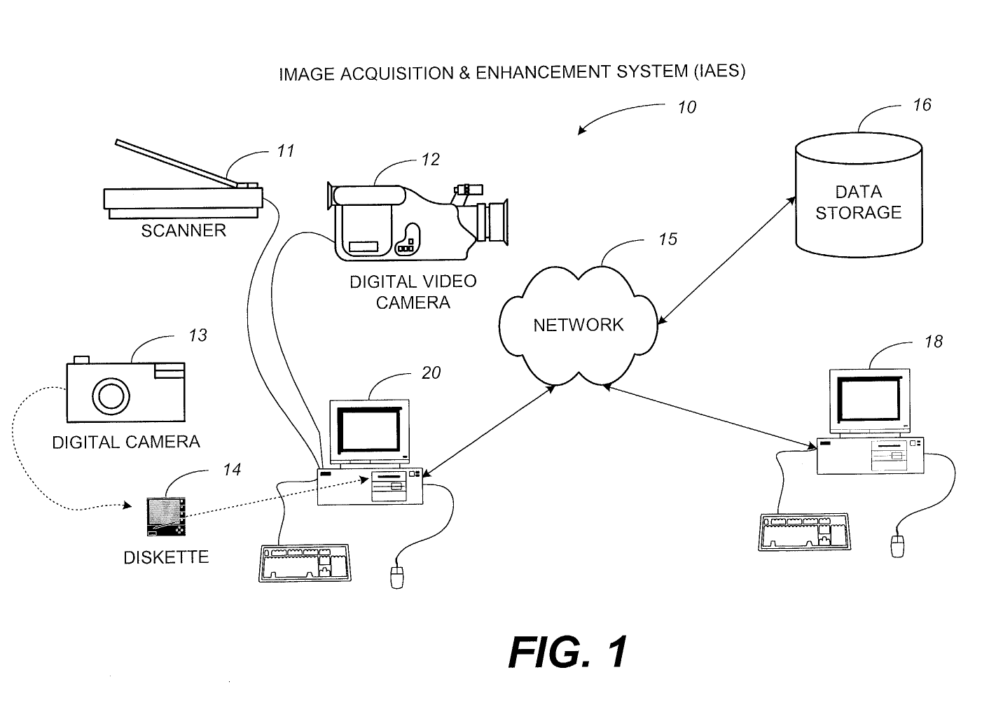

Referring now in more detail to the drawings, in which like numerals indicate corresponding parts throughout the several views, attention is now directed to FIG. 1, which illustrates a schematic diagram of an image acquisition and enhancement system. As illustrated in FIG. 1, the image acquisition and enhancement system is generally denoted by reference numeral 10 and may include a scanner 11, a digital-video camera 12, a digital camera 13, a network 15, a data-storage device 16, and one or more general-purpose computers 18, 20. The general-purpose computers 18, 20 are communicatively coupled with each other and to the data-storage device 16 via the network 15.

The image acquisition and enhancement system (IAES) 10 includes at least one image-acquisition device (e.g., the scanner 11, digital-video camera12, and digital camera 13, etc.) communicatively coupled to general-purpose computer 20. As shown in FIG. 1, general-purpose computers 18, 20 may receive digital images either directly via an image-acquisition device, or indirectly by way of various portable-storage media such as floppy disk 14.

It will be appreciated that a host of other portable data-storage media may also be used to transfer one or more digital images to each of the general-purpose computers 18, 20. Some popular data-storage media suitable to transfer digital-data images include compact disks (CDs), magnetic tapes, and portable-hard drives.

Digital images that may be processed by the IAES 10 include, for example, but not limited to, scanned images, digital photographs, digital video, medical images, etc. It will be appreciated that not all digital images received at the general-purpose computers 18, 20 will be deemed entirely acceptable by an operator of the associated computer or image-acquisition device. In order to compensate, film photographers often take multiple exposures of similar subject matter in the hopes of receiving a few good photographs. Many of today's digital image-acquisition devices compensate by providing real-time feedback via a display device. Acquired images that are deemed unacceptable in real-time may be deleted and the memory within the image-acquisition device reallocated for new images. While displays associated with image-acquisition devices continually advance, often flaws are detected or identified in stored-digital images after the opportunity has passed to capture a replacement image.

For example, consider the bride and groom who review their wedding day photos on their honeymoon and discover that a nearly perfect image of the couple with both sets of in-laws is not very flattering because the mother of the bride was blinking at the time the image was captured. In the past, the bride might decide not to distribute that particular image. An operator of the IAES 10 may transfer the “flawed” image along with other images captured on the wedding day to general-purpose computer 20 configured with an image enhancer to generate a more acceptable image.

Enhancements can include, for example, but are not limited to, positional editing of a particular feature on a subject of an image or their clothing, removing an undesirable object from an image, covering a spot or flaw on the source image, and/or selectively removing various icons, symbols, tattoos, and the like from the source image. In some embodiments, the operator identifies an undesirable region on a source or baseline image, as well as a proposed substitute region from either a related image or another region of the baseline image.

An image-enhancer application in communication with an image editor, or having its own image editor, overlays the proposed-substitute region over the undesirable region on the baseline image. The image enhancer then presents the operator with an interrogatory configured to determine what image-processing parameters associated with the substitute region may make the modification stand out from the baseline image. Preferably, the interrogatory is layered to illicit that information from the operator that results in a minimum set of questions to the operator that will provide the associated-image processor with appropriate modified parameters to generate an acceptable composite image.

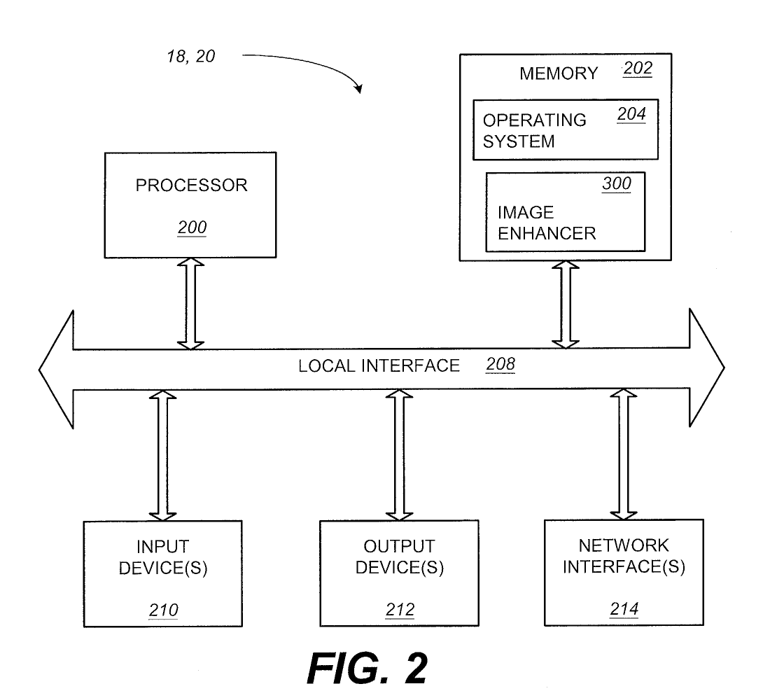

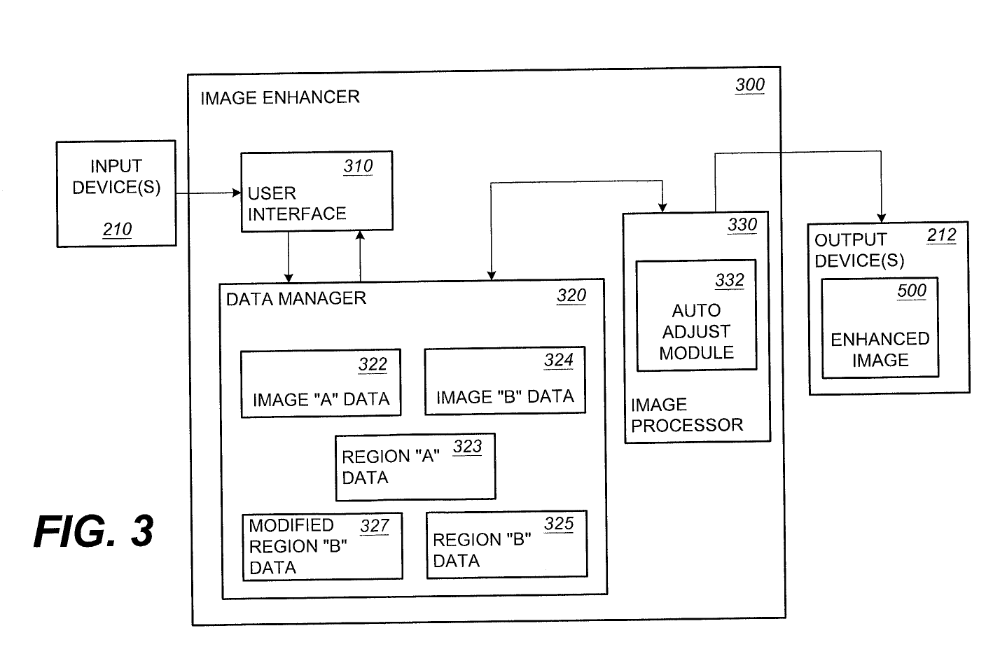

The image-enhancer application, which will be described in detail with regard to the functional-block diagram of FIG. 3 can be operable in a general-purpose computer 18, 20 and/or on an appropriately configured image-acquisition device. General-purpose computers 18, 20 may take the form of a personal computer (PC; IBM-compatible, Apple-compatible, or otherwise), workstation, minicomputer, or mainframe computer. A functional-block diagram of exemplar general-purpose computers 18, 20 that can implement the image enhancer of the IAES 10 is shown in FIG. 2. Modified image-acquisition devices (e.g., the scanner, a digital-video camera, a digital camera, etc.) may also be configured to implement the image enhancer.

The computers and/or image-acquisition systems may include a processor 200, memory 202, input devices 210, output devices 212, and network interfaces 214 that communicate with each other via a local interface 208. The local interface 208 can be, but is not limited to, one or more buses or other wired or wireless connections as is known in the art. The local interface 208 may have additional elements, such as buffers (caches), drivers, and controllers (omitted here for simplicity), to enable communications. Further, the local interface 208 includes address, control, and data connections to enable appropriate communications among the aforementioned components.

The processor 200 is a hardware device for executing software stored in memory 202. The processor 200 can be any custom made or commercially available processor, a central-processing unit (CPU) or an auxiliary processor among several processors, and a microprocessor or macroprocessor. Examples of suitable commercially available microprocessors include: a PA-RISC® series microprocessor from Hewlett-Packard Company, an 80x86 or Pentium® series microprocessor from Intel Corporation, a PowerPC® microprocessor from IBM, a Sparc® microprocessor from Sun Microsystems, Inc, or a 68xxx series microprocessor from Motorola Corporation.

The memory 202 can include any one or a combination of volatile-memory elements, such as random-access memory (RAM, DRAM, SDRAM, etc.), and non-volatile memory elements, such as read-only memory (ROM), hard-drive, tape, compact disc (CD) ROM, etc. Moreover, the memory 202 may incorporate electronic, magnetic, optical, and/or other types of storage media.

The information stored in memory 202 may include one or more separate programs comprised of executable instructions for implementing logical functions. In the example of FIG. 2, the software in memory 202 includes the image enhancer 300 and a suitable operating system 204. A non-exhaustive list of commercially available operating systems includes Windows® from Microsoft Corporation, Netware® from Novell, and UNIX®, which is available from many vendors. The operating system 204 controls the execution of other computer programs, such as the image enhancer 300, and provides scheduling, input/output control, file management, memory management, communication control, and other related services. Note that the memory 202 can have a distributed architecture, where various components are situated remote from one another, but accessible by the processor 200.

The image-enhancer application 300 can be a source program, executable program (object code), script, or any other entity comprising a set of instructions to be performed. When implemented as a source program, then the program needs to be translated via a compiler, assembler, interpreter, or the like, which may or may not be included within the memory 202, so as to operate properly in connection with the operating system 204.

The input devices 210 may include a microphone, keyboard, mouse, and/or other interactive pointing devices, voice-activated interfaces, or other suitable operator-machine interfaces. The input devices 210 can also take the form of various image-acquisition devices. Each of the input devices 210 may be in communication with the processor 200 and/or the memory 202 via the local interface 208. It is significant to note that data received from an image-acquisition device connected as an input device 210 or via the network interface 214 may take the form of images that are stored in memory 202 as image files. Moreover, data files containing one or more images may be received via network interfaces 214 from the data-storage device 16 (FIG. 1), as well as other computers associated with network 15 (FIG. 1).

The output devices 212 may include a video interface that supplies a video-output signal to a display monitor associated with the computer and/or image-acquisition system. Display monitors associated with these devices can be conventional CRT based displays, liquid crystal displays (LCDS), plasma displays, or other display types. The output devices 212 may also include other well-known devices such as plotters, printers, and various film developers. For simplicity of illustration, various input devices 210 and output devices 212 are not shown.

The local interface 208 may also be in communication with input/output devices that connect the computers and/or image-acquisition devices to network 15. These two-way communication devices include, but are not limited to, modulators/demodulators (modems), network cards, radio frequency (RF) or other transceivers, telephonic interfaces, bridges, and routers. For simplicity of illustration, such two-way communication devices are also not shown.

When the general-purpose computer 18, 20 and/or image-acquisition device is in operation, the processor 200 executes software stored in memory 202, communicates data to and from memory 202, and generally controls operations of the underlying device pursuant to the software. The image enhancer 300, the operating system 204, and other applications are read, in whole or in part, by the processor 200, buffered by the processor 200, and executed.

Image-Enhancer Architecture and Operation

Reference is now directed to the functional-block diagram of FIG. 3, which further illustrates the image enhancer 300 of FIG. 2. Shown here, the image enhancer 300 may include a user interface 310, a data manager 320, and an image processor 330. As illustrated in FIG. 3, the user interface 310 is in communication with one or more input devices 210 and the data manager 320.

The user interface 310 may consist of a plurality of data-entry windows or frames that are presented to an operator of the IAES 10 (FIG. 1). In this regard, the user interface 310 may include a graphical-user interface (GUI) that is easily recognizable and operable by casual computer users. For example, the user interface 310 may display application windows, a menu bar, and a command bar containing one or more file command push-buttons and one or more format command push-buttons. It is important to note that while the user interface 310 has been described in terms of data-entry windows and frames, it could just as easily be implemented through voice-activated commands or other human to system interfaces. It should be appreciated by those skilled in the art that the image enhancer 300 is not limited to a particular implementation of the user interface 310 and in fact may contain both voice-activated and GUIs as well as other interfaces.

The data manager 320 is in communication with both the user interface 310 and the image processor 330 as illustrated in the functional-block diagram of FIG. 3. As further illustrated, the data manager 320 may be configured to handle a plurality of images including image “A” data 322 and image “B” data 324. In addition, the data manager is configured to handle a plurality of regions including region “A” data 323, region “B” data 325, and modified region “B” data 327.

Region “A” data 323 includes information that defines a region of interest from image “A” data 322. The region “A” data 323 defines an area of a baseline image that an operator of the IAES 10 deems flawed or undesirable in some way. As previously discussed, the flawed region may contain a contorted facial feature, a stain or other mark on clothing, and other similar items that may be deemed unacceptable by the operator.

Region “B” data 325 includes a region of interest from a related image such as image “B” data 324 that the operator defines via the user interface 310 as a potential substitute for the flawed region “A” data 323. It should be appreciated that under some conditions, such as a stain or undesirable symbol on an article of clothing, the region “B” data 325 may be selected from a separate sub-region of the image “A” data 322. Under most conditions however, the region “B” data 325 will be identified by an operator from the related image “B” data 324. The region “B” data 325 includes information that both defines the boundaries of a proposed-substitute region of interest from a related image or a portion of the baseline image as described above, but the underlying image data as well.

Once the operator of the IAES 10 has identified the related images (i.e., image “A” data 322 and image “B” data 324), the flawed region from a baseline image, and a proposed-substitute region from a related image (i.e., region “A” data 323 and region “B” data 325) the image enhancer 300 may be programmed to transfer the various image data to the image processor 330. Upon receipt of the replacement or substitute data, the image processor may be programmed to identify and align one or more reference points from the underlying image “A” data 322 and the region “B” data 325 so as to locate and size the substitute-image information within the image “A” data 322 to produce an interim modified image (not shown).

It will be appreciated that for a number of reasons, the image information contained within the region “B” data 325 may not acceptably match the surrounding image information from the remaining image “A” data 322 after the initial substitution. For example, the lighting conditions under which the image “A” data 322 and the image “B” data 324 were acquired may have been different. As a result, it may be easy to identify that portion of the interim-modified image because of perceived color, brightness, contrast, and/or other image-parameter differences.

At this point, the image enhancer 300, via the user interface 310, will enter an interrogatory session programmed to illicit information from the operator that indicate one or more image-processing parameter changes that when applied by the image processor over the region “B” data 325 will result in a modified version of the region “B” data 327 that when inserted or overlayed on the image “A” data 322, will generate a modified image “A” (not shown) that will be acceptable to the operator. The image-enhancer logic may use various criteria to determine appropriate questions to present to the operator based on both previous responses, as well as image statistics derived from an analysis of the surrounding regions of the base image. In some embodiments, the image-enhancer logic uses the image statistics from the surrounding regions of the base image to preset image-processing parameters applied over the substitute region.

Furthermore, these embodiments present both the first-generation image containing the unmodified region “B” data 325 identified by the operator as well as the next-generation modified image in a format that facilitates comparison by an operator of the system. The data manager 320 and user interface 310 may work together to generate an enhanced-image instance 500 that displays image data in a number of different layouts and formats. These layouts and formats may be dictated by the underlying imaging modality used to acquire the digital images (photographs, video, medical diagnostics, etc.) or may be configured by the user. Typical displays may contain dual images, thumbnail displays, or a composite of multiple related images. In some embodiments, suited for more advanced users of image-editing software, the user interface 310 may provide image statistics for both the baseline and the substitute regions of the first-generation image, as well as the modified-substitute region in addition to the image data.

Next, the image enhancer 300 presents a series of questions regarding the perceptible differences between the baseline image and the substitute region. For example, the image enhancer 300 may prompt the operator for answers regarding the relative positioning of the substitute data with regard to the underlying baseline image. The image enhancer 300 may prompt the operator for information regarding the relative brightness between the substitute image and the underlying baseline image. Other differences may be identified as well, including but not limited to color, hue, contrast, sharpness, etc.

The image processor 330 in communication with the data manager 320 and the output devices 212 may take many different forms. In some embodiments, the image processor 330 is implemented in software and configured to apply a plurality of algorithms to the digital data comprising each of the substitute image regions 325 identified by an operator of the IAES 10.

Digital-Image Processing Algorithms

Operations fundamental to digital-image processing can be divided into four categories: operations based on an image histogram, on simple mathematics, on convolution, and on mathematical morphology. Further, these operations can also be described in terms of their implementation as a point operation, a local operation, or a global operation.

A. Histogram-Based Operations

Histogram-based operations include contrast stretching, equalization, as well as other histogram-based operations. An important class of point operations is based upon the manipulation of an image histogram or a region histogram. The most important examples are described below.

1. Contrast Stretching

Frequently, an image is scanned in such a way that the resulting brightness values do not make full use of the available dynamic range. The scanned image can be improved by stretching the histogram over the available dynamic range. If the image is intended to go from brightness 0 to brightness 2^{B}−1, then one generally maps the 0% value (or minimum value) to the value 0 and the 100% value (or maximum value) to the value 2^{B}−1. The appropriate transformation is given by:

$$b [ m , n ] = ( {2}^{B} - 1 ) \cdot \frac{a [ m , n ] - min imum}{max imum - min imum} . \qquad Eq . 1$$

This formula, however, can be somewhat sensitive to outliers and a less sensitive and more general version is given by:

$$\begin{matrix}b [ m , n ] = 0 , & where a [ m , n ] \leq {p}_{low} \% \\ b [ m , n ] = ( {2}^{B} - 1 ) \cdot \frac{a [ m , n ] - {p}_{low} \%}{{p}_{high} \% - {p}_{low} \%} , & where {p}_{low} \% < a [ m , n ] < {p}_{high} \% \\ b [ m , n ] = ( {2}^{B} - 1 ) , & where a [ m , n ] \geq {p}_{high} \%\end{matrix} \qquad Eq . 2$$

In this second version, the 1% and 99% values may be selected for p_{low} % and p_{high} %, respectively, instead of the 0% and 100% values represented by Eq. 1. It is also possible to apply the contrast-stretching operation on a regional basis using the histogram from a region to determine the appropriate limits for the algorithm. Note that in Eqs. 1 and 2 it is possible to suppress the term 2^{B}−1 and simply normalize the brightness range to 0<=b[m,n]<=1. This means representing the final-pixel brightness values as real values instead of integers. Modern computer speeds and RAM capacities make this quite feasible.

2. Equalization

When looking to compare two or more images on a specific basis, such as texture, it is common to first normalize their histograms to a “standard” histogram. This can be especially useful when the images have been acquired under different circumstances. The most common histogram normalization technique is histogram equalization where one attempts to change the histogram through a function b=ƒ(a) into a histogram that is constant for all brightness values. This would correspond to a brightness distribution where all values are equally probable. Unfortunately, for an arbitrary image, the result can only be approximated.

For a “suitable” function ƒ(*) the relation between the input-probability density function, the output-probability density function, and the function ƒ(*) is given by:

$${p}_{b} ( b ) ⅆ b = {p}_{a} ( a ) ⅆ a ⇒ ⅆ f = \frac{{p}_{a} ⅆ a}{{p}_{b} ( b )} . \qquad Eq . 3$$

From Eq. 3 we see that “suitable” means that ƒ(*) is differentiable and that d/da≧0. For histogram equalization, we desire that p_{b}(b)=a constant. Thus,

ƒ(a)=(2^{B}−1)·P(a) Eq. 4

where, P(a), is the probability-distribution function. In other words, the quantized probability-distribution function normalized from 0 to 2^{B}−1 is the look-up table required for histogram equalization. The histogram equalization procedure can also be applied on a regional basis.

3. Other Histogram-Based Operations (Filtering)

The histogram derived from a local region can also be used to drive local filters that are to be applied to that region. Examples include minimum filtering, median filtering, and maximum filtering. Filters based on these concepts are well-known and understood by those skilled in the art.

Mathematics-Based Operations

This section describes binary arithmetic and ordinary arithmetic. In the binary case there are two brightness values “0” and “1.” In ordinary situations, there are 2^{B} brightness values or levels but the processing of the image can easily generate many more levels. For this reason, many software systems provide 16 or 32-bit representations for pixel-brightness values to avoid problems with arithmetic overflow.

1. Binary Operations

Operations based on binary (Boolean) arithmetic form the basis for a powerful set of tools that will be described here and under the section describing mathematical morphology. The operations described below are point operations and thus admit a variety of efficient implementations including simple look-up tables. The standard notation for the basic set of binary operations is as follows:

| | |
|---|---|
| NOT | c = \overline{a} |
| OR | c = a + b |
| AND | c = a • b |
| XOR | x = a ⊕ b = a • \overline{b} + \overline{a} • b |
| SUB | c = a\b = a − b = a •\overline{b} |

The implication is that each operation is applied on a pixel-by-pixel basis. For example, c[m,n]=a[m,n]·\overline{b}[m,n] ∀m,n. The definition of each operation is:

TABLE I
Binary Operations.
NOT

| a | |
|---|---|
| 0 | 1 |
| 1 | 0 |

OR

b

| a | 0 | 1 |
|---|---|---|
| 0 | 0 | 1 |
| 1 | 1 | 1 |

AND

b

| a | 0 | 1 |
|---|---|---|
| 0 | 0 | 0 |
| 1 | 0 | 1 |

XOR

b

| a | 0 | 1 |
|---|---|---|
| 0 | 0 | 1 |
| 1 | 1 | 0 |

SUB

b

| a | 0 | 1 |
|---|---|---|
| 0 | 0 | 0 |
| 1 | 1 | 0 |

The SUB(*) operation can be particularly useful when image a represents a region-of-interest that has been analyzed systematically and image b represents objects that having been analyzed, can now be discarded, that are subtracted, from the region.

2. Arithmetic-Based Operations

The gray-value point operations that form the basis for image processing are based on ordinary mathematics and include:

TABLE II
Arithmetic-Based Operations.

| Operation | Definition | preferred data type |
|---|---|---|
| ADD | c = a + b | integer |
| SUB | c = a − b | integer |
| MUL | c = a * b | integer or floating point |
| DIV | c = a/b | floating point |
| LOG | c = log(a) | floating point |
| EXP | x = exp(a) | floating point |
| SQRT | x = sqrt(a) | floating point |
| TRIG. | c = sin/cos/tan(a) | floating point |
| INVERT | c = (2^{B} − 1) − a | integer |

Convolution-Based Operations

Convolution is central to modern-image processing. The basic idea is that a window of some finite size and shape—the support—is scanned across the image. The output-pixel value is the weighted sum of the input pixels within the window where the weights are the values of the filter assigned to every pixel of the window itself. The window with its weights is called the convolution kernel. If the filter h[j,k] is zero outside the (rectangular) window {j=0, 1, . . . , J−1; k=0, 1, . . . , K−1}, then, the convolution can be written as the following finite sum:

$$c [ m , n ] = a [ m , n ] ⊗ h [ m , n ] = {\sum }_{j = 0}^{J - 1} {\sum }_{k = 0}^{K - 1} h [ j , k ] a [ m - j , n - k ] \qquad Eq . 5$$

This equation can be viewed as more than just a pragmatic mechanism for smoothing or sharpening an image. The operation can be implemented through the use of the Fourier domain, which requires a global operation, the Fourier transform.

1. Background

In a variety of image-forming systems an appropriate model for the transformation of the physical signal a(x,y) into an electronic signal c(x,y) is the convolution of the input signal with the impulse response of the sensor system. This system might consist of both an optical, as well as an electrical sub-system. If each of these systems can be treated as a linear shift-invariant (LSI) system then the convolution model is appropriate. The definitions of these two, possible, system properties are given below:

Linearity

If a₁→c₁ and a₂→c₂

Then, w₁·a₁+w₂·a₂→w₁·c₁+w₂·c₂.

Shift-Invariance

If a(x,y)→c(x,y)

Then, a(x−x₀,y−y₀)→c(x−x₀,y−y₀)

where w₁ and w₂ are arbitrary complex constants and xₒ and yₒ are coordinates corresponding to arbitrary spatial translations.

Two remarks are appropriate at this point. First, linearity implies (by choosing w₁=w₂=0) that “zero in” gives “zero out.” Consequently, systems such as cameras that do not abide by this relationship are not linear systems and thus (strictly speaking) the convolution result is not applicable. Fortunately, it is straightforward to correct for this non-linear effect.

Second, optical lenses with a magnification, M, other than 1× are not shift invariant; a translation of 1 unit in the input image a(x,y) produces a translation of M units in the output image c(x,y). However, this case can still be handled by linear system theory.

If an impulse point of light d(x,y) is imaged through an LSI system then the impulse response of that system is called the point-spread function (PSF). The output image then becomes the convolution of the input image with the PSF. The Fourier transform of the PSF is called the optical-transfer function (OTF). If the convolution window is not the diffraction-limited PSF of the lens but rather the effect of defocusing a lens then an appropriate model for h(x,y) is a pill box of radius a. The effect of the defocusing is more than just simple blurring or smoothing. The almost periodic negative lobes in the transfer function produce a 180 deg. phase shift in which black turns to white and vice-versa.

2. Convolution in the Spatial Domain

In describing filters based on convolution we will use the following convention. Given a filter h[j,k] of dimensions J×K, we will consider the coordinate [j=0,k=0] to be in the center of the filter matrix, h. The “center” is well-defined when J and K are odd; for the case where they are even, the approximations (J/2, K/2) for the “center” of the matrix can be used.

Several issues become evident upon close examination of the convolution sum (Eq. 5). Evaluation of the formula for m=n=0 while rewriting the limits of the convolution sum based on the “centering” of h[j,k] shows that values of a[j,k] can be required that are outside the image boundaries:

$$\begin{matrix}c [ 0 , 0 ] = {\sum }_{j = {J}_{0}}^{+ {J}_{0}} {\sum }_{k = - {K}_{0}}^{+ {K}_{0}} h [ j , k ] a [ - j , - k ] & {J}_{0} = \frac{( J - 1 )}{2} , {K}_{0} = \frac{( K - 1 )}{2}\end{matrix} \qquad Eq . 6$$

The question arises—what values should be assigned to the image a[m,n] for m<0, m>=M, n<0, and n>=N? There is no “answer” to this question. There are only alternatives among which to choose. The standard alternatives are a) extend the images with a constant (possibly zero) brightness value, b) extend the image periodically, c) extend the image by mirroring it at its boundaries, or d) extend the values at the boundaries indefinitely.

When the convolution sum is written in the standard form (Eq. 5) for an image a[m,n] of size M×N:

$$c [ m , n ] = {\sum }_{j = 0}^{M - 1} {\sum }_{k = 0}^{N - 1} a [ j , k ] h [ m - j , n - k ] \qquad Eq . 7$$

the convolution kernel, h[j,k], is mirrored around j=k=0 to produce h[−j,−k] before it is translated by [m,n] as indicated in Eq. 6. While some convolution kernels in common use are symmetric in this respect, h[j,k]=h[−j,−k], many are not. Therefore, care should be taken in the implementation of filters with respect to mirroring requirements.

The computational complexity for a K×K convolution kernel implemented in the spatial domain on an image of N×N is O(K²) where the complexity is measured per pixel on the basis of the number of multiplies-and-adds (MADDs).

The value computed by a convolution that begins with integer brightness values for a[m,n] may produce a rational number or a floating-point number in the result c[m,n]. Working exclusively with integer-brightness values, will therefore, cause roundoff errors.

Inspection of Eq. 8 reveals another possibility for efficient implementation of convolution. If the convolution kernel, h[j,k], is separable, that is, if the kernel can be written as:

h[j,k]=h_{row}[k]·h_{col}[j] Eq. 8

then, the filtering can be performed as follows:

$$c [ m , n ] = {\sum }_{j = 0}^{J - 1} ( {\sum }_{k = 0}^{K - 1} {h}_{row} [ k ] a [ m - j , n - k ] ) {h}_{col} [ j ] \qquad Eq . 9$$

This means that instead of applying one, two-dimensional filter it is possible to apply two, one-dimensional filters, the first one in the k direction and the second one in the j direction. For an N×N image this, in general, reduces the computational complexity per pixel from O(J*K) to O(J+K).

An alternative way of writing separability is to note that the convolution kernel is a matrix h and, if separable, h can be written as:

[h]=[h_{col}]·[h_{row}]^{t}

(J×K)=(J×1)·(1×K) Eq. 10

where, “^{t}” denotes the matrix transpose operation. In other words, h, can be expressed as the outer product of a column vector [h_{col}] and a row vector [h_{row}].

For certain filters it is possible to find an incremental implementation for a convolution. As the convolution window moves over the image, the leftmost column of image data under the window is shifted out as a new column of image data is shifted in from the right. Efficient algorithms can take advantage of this and, when combined with separable filters as described above, this can lead to algorithms where the computational complexity per pixel is O(constant).

Convolution in the Frequency Domain

An alternative method to implement the filtering of images through convolution appears below. It appears possible to achieve the same result as in Eq. 10 by the following sequence of operations:

i) Compute A(Ω, Ψ)=F{a[m,n]}

ii) Multiply A(Ω, Ψ) by the precomputed (Ω, Ψ)=F{h[m,n]}

iii) Compute the result c[m,n]=F⁻¹{A(Ω, Ψ)*(Ω, Ψ)}

While it might seem that the “recipe” given in the operations above circumvents the problems associated with direct convolution in the spatial domain—specifically, determining values for the image outside the boundaries of the image—the Fourier domain approach, in fact, simply “assumes” that the image is repeated periodically outside its boundaries. This phenomenon is referred to as circular convolution.

If circular convolution is not acceptable, then other possibilities can be realized by embedding the image a[m,n] and the filter (Ω, Ψ) in larger matrices with the desired image-extension mechanism for a[m,n] being explicitly implemented.

The computational complexity per pixel of the Fourier approach for an image of N×N and for a convolution kernel of K×K is O(logN) complex MADDS independent of K. Here, assume that N>K and that N is a composite number such as a power of two. This latter assumption permits use of the computationally efficient Fast-Fourier Transform (FFT) algorithm. Surprisingly then, the indirect route described by Eq. 10 can be faster than the direct route given in the operations listed above. This requires, in general, that K²>>logN. The range of K and N for which this holds depends on the specifics of the implementation. In some embodiments, for an image of N=256 the Fourier approach is faster than the convolution approach when K>=15. (It should be noted that in this comparison the direct convolution involves only integer arithmetic while the Fourier domain approach requires complex floating-point arithmetic.)

Smoothing Operations

Smoothing algorithms are applied to reduce noise and/or to prepare images for further processing such as segmentation. Smoothing algorithms may be both linear and non-linear. Linear algorithms are amenable to analysis in the Fourier domain. Whereas, non-linear algorithms can not be analyzed in the Fourier domain. Smoothing algorithms can also be distinguished between implementations based on a rectangular support for the filter and implementations based on a circular support for the filter.

1. Linear Filters

Several filtering algorithms are presented below with some of the most useful supports.

Uniform Filter

The output image is based on a local averaging of the input filter where all of the values within the filter support have the same weight. For the discrete-spatial domain [m,n] the filter values are the samples of the continuous domain case. Examples for the rectangular case (J=K=5) and the circular case (R=2.5) are shown below.

$$\begin{matrix}{h}_{rect} [ j , k ] = \frac{1}{25} [ \begin{matrix}1 & 1 & 1 & 1 & 1 \\ 1 & 1 & 1 & 1 & 1 \\ 1 & 1 & 1 & 1 & 1 \\ 1 & 1 & 1 & 1 & 1 \\ 1 & 1 & 1 & 1 & 1\end{matrix} ] & {h}_{circ} [ j , k ] = \frac{1}{21} [ \begin{matrix}0 & 1 & 1 & 1 & 0 \\ 1 & 1 & 1 & 1 & 1 \\ 1 & 1 & 1 & 1 & 1 \\ 1 & 1 & 1 & 1 & 1 \\ 0 & 1 & 1 & 1 & 0\end{matrix} ] \\ ( a ) Rectangular filte r ( J = K = 5 ) & ( b ) Circular filter ( R = 2.5 )\end{matrix}$$

Note that in both cases the filter is normalized so that Σh[j,k]=1. This is done so that if the input a[m,n] is a constant then the output image c[m,n] is the same constant. The square implementation of the filter is separable and incremental; the circular implementation is incremental.

Triangular Filter

The output image is based on a local averaging of the input filter where the values within the filter support have differing weights. In general, the filter can be seen as the convolution of two (identical) uniform filters either rectangular or circular and this has direct consequences for the computational complexity. Examples for the rectangular support case (J=K=5) and the circular support case (R=2.5) are shown below. The filter is again normalized so that Σh[j,k]=1.

$$\begin{matrix}{h}_{rect} [ j , k ] = \frac{1}{81} [ \begin{matrix}1 & 2 & 3 & 2 & 1 \\ 2 & 4 & 6 & 4 & 2 \\ 3 & 6 & 9 & 6 & 3 \\ 2 & 4 & 6 & 4 & 2 \\ 1 & 2 & 3 & 2 & 1\end{matrix} ] & {h}_{circ} [ j , k ] = \frac{1}{25} [ \begin{matrix}0 & 0 & 1 & 0 & 0 \\ 0 & 2 & 2 & 2 & 0 \\ 1 & 2 & 5 & 2 & 1 \\ 0 & 2 & 2 & 2 & 0 \\ 0 & 0 & 1 & 0 & 0\end{matrix} ] \\ ( a ) Pyramidal filter ( J = K = 5 ) & ( b ) Cone filter ( R = 2.5 )\end{matrix}$$

Gaussian Filter

The use of the Gaussian kernel for smoothing has become extremely popular. This has to do with certain properties of the Gaussian (e.g., the central limit theorem, minimum space-bandwidth product), as well as several application areas such as edge finding and scale space analysis. The Gaussian filter is separable:

$$h ( x , y ) = {g}_{2 D} ( x , y ) = ( \frac{1}{\sqrt{2 π} σ} {ⅇ}^{- ( {x}^{2} / 2 {σ}^{2} )} ) \cdot ( \frac{1}{\sqrt{2 π} σ} {ⅇ}^{- ( {y}^{2} / 2 {σ}^{2} )} ) = {g}_{1 D} ( x ) \cdot {g}_{1 D} ( y ) \qquad Eq . 11$$

There are four distinct ways to implement the Gaussian:

a) Convolution using a finite number of samples (Nₒ) of the Gaussian as the convolution kernel. It is common to choose Nₒ=[3σ] or [5σ].

$$\begin{matrix}{g}_{1 D} [ n ] = \frac{1}{\sqrt{2 π} σ} {ⅇ}^{- ( \frac{{n}^{2}}{2 {σ}^{2}} )} & \vert n \vert \leq {N}_{0} \\ {g}_{1 D} [ n ] = 0 & \vert n \vert > {N}_{0}\end{matrix} \qquad Eq . 12$$

b) Repetitive convolution using a uniform filter as the convolution kernel.

g_{1D}[n]≈u[n]\mathring{x}u[n]\mathring{x}u[n]

where, u[n]=2/(2N₀+1) |n|≦N₀

u[n]=0|n|>N₀ Eq. 13

The actual implementation (in each dimension) is usually of the form:

c[n]=((a[n]\mathring{x}u[n])\mathring{x}u[n])\mathring{x}u[n].

This implementation makes use of the approximation afforded by the central limit theorem. For a desired σ with Eq. 12, Nₒ can be set to |σ| although this severely restricts the choice of σ's to integer values.

c) Multiplication in the Frequency Domain

As the Fourier transform of a Gaussian is a Gaussian, this means that it is straightforward to prepare a filter (Ω, Ψ)=G_{2D}(Ω, Ψ) for use with Eq. 11. To avoid truncation effects in the frequency domain due to the infinite extent of the Gaussian, it is important to choose a σ that is sufficiently large. Choosing σ>k/π where k=3 or 4 will usually be sufficient.

d) Use of a Recursive Filter Implementation

A recursive filter has an infinite impulse response and thus an infinite support.

The separable Gaussian filter can also be implemented by applying the following recipe in each dimension when σ>=0.5.

i) Choose σ the based on the desired goal of the filtering;

ii) Determine the parameter q based on Eq. 14;

iii) Use Eq. 15 to determine the filter coefficients {b₀, b₁, b₂, b₃, B};

iv) Apply the forward difference equation, Eq. 16;

v) Apply the backward difference equation, Eq. 17;

The relation between the desired and q is given by:

q=0.98711σ−0.96330 σ≧2.5

q=3.97156−4.14554\sqrt{1−0.26891σ} 0.5≦σ≦2.5 Eq. 14

The filter coefficients {b₀, b₁, b₂, b₃, B} are defined by:

b₀=1.57825+(2.44413q)+(1.4281q²)+(0.422205q³)

b₁=(2.44413q)+(2.85619q²)+(1.26661q³)

b₂=−(1.4281q²)−(1.26661q³)

b₃=0.422205q³

B=1−(b₁+b₂+b₃)/b₀ Eq. 15

The one-dimensional forward difference equation takes an input row (or column) a[n] and produces an intermediate output result w[n] given by:

w[n]=Ba[n]+(b₁w[n−1]+b₂w[n−2]+b₃w[n−3])/b₀ Eq. 16

The one-dimensional backward difference equation takes the intermediate result w[n] and produces the output c[n] given by:

c[n]=Bw[n]+(b₁c[n+1]+b₂c[n+2]+b₃c[n+3])/b₀ Eq. 17

The forward equation is applied from n=0 up to n=N−1 while the backward equation is applied from n=N−1 down to n=0.

Other (Linear) Filters

The Fourier domain approach offers the opportunity to implement a variety of smoothing algorithms. The smoothing filters will then be lowpass filters. In general it is desirable to use a lowpass filter that has zero phase to not produce phase distortion when filtering the image. When the frequency-domain characteristics can be represented in an analytic form, then this can lead to relatively straightforward implementations of (Ω, Ψ).

2. Non-Linear Filters

A variety of smoothing filters have been developed that are not linear. While they cannot, in general, be submitted to Fourier analysis, their properties and domains of application have been studied extensively.

Median Filter

A median filter is based upon moving a window over an image (as in a convolution) and computing the output pixel as the median value of the brightness values within the input window. If the window is J×K in size we can order the J*K pixels in brightness value from smallest to largest. If J*K is odd then the median will be the (J*K+1)/2 entry in the list of ordered brightness values. Note that the value selected will be exactly equal to one of the existing brightness values so that no roundoff error will be involved if we want to work exclusively with integer brightness values. The algorithm as it is described above has a generic complexity per pixel of O(J*K*log(J*K)). Fortunately, a fast algorithm exists that reduces the complexity to O(K) assuming J>=K.

A useful variation on the theme of the median filter is the percentile filter. Here the center pixel in the window is replaced not by the 50% (median) brightness value but rather by the p % brightness value where p % ranges from 0% (the minimum filter) to 100% (the maximum filter). Values other then (p=50)% do not, in general, correspond to smoothing filters.

Kuwahara Filter

Edges play an important role in the perception of images, as well as in the analysis of images. As such, it is important to be able to smooth images without disturbing the sharpness and, if possible, the position of edges. A filter that accomplishes this goal is termed an edge-preserving filter and one particular example is the Kuwahara filter. Although this filter can be implemented for a variety of different window shapes, the algorithm will be described for a square window of size J=K=4L+1 where L is an integer. The window is partitioned into four regions. When L=1 and thus J=K=5. Each region is [(J+1)/2]×[(K+1)/2].

In each of the four regions (i=1, 2, 3, 4), the mean brightness, mᵢ and the varianceᵢ, sᵢ² are measured. The output value of the center pixel in the window is the mean value of that region that has the smallest variance.

Summary of Smoothing Algorithms

The following table summarizes the various properties of the smoothing algorithms presented above. The filter size is assumed to be bounded by a rectangle of J×K where, without loss of generality, J>=K. The image size is N×N.

TABLE III
Characteristics of Smoothing Filters.

| | | | | | |
|---|---|---|---|---|---|
| Algorithm | Domain | Type | Support | Separable/Incremental | Complexity/pixel |
| Uniform | Space | Linear | Square | Y/Y | O(constant) |
| Uniform | Space | Linear | Circular | N/Y | O(K) |
| Triangle | Space | Linear | Square | Y/N | O(constant)^{a} |
| Triangle | Space | Linear | Circular | N/N | O(K)^{a} |
| Gaussuan | Space | Linear | ^{a} | Y/N | O(constant)^{a} |
| Median | Space | Non-Linear | Square | N/Y | O(K)^{a} |
| Kuwahara | Space | Non-Linear | Square^{a} | N/N | O(J* K) |
| Other | Frequency | Linear | — | —/— | O(logN) |

Derivative-Based Operations

Just as smoothing is a fundamental operation in image processing so is the ability to take one or more spatial derivatives of the image. The fundamental problem is that, according to the mathematical definition of a derivative, this cannot be done. A digitized image is not a continuous function a(x,y) of the spatial variables but rather a discrete function a[m,n] of the integer-spatial coordinates. As a result, the algorithms presented can only be seen as approximations to the true spatial derivatives of the original spatially-continuous image.

Further, as we can see from the Fourier property, taking a derivative multiplies the signal spectrum by either u or v. This means that high-frequency noise will be emphasized in the resulting image. The general solution to this problem is to combine the derivative operation with one that suppresses high-frequency noise, in short, smoothing in combination with the desired derivative operation.

First Derivatives

As an image is a function of two (or more) variables it is necessary to define the direction in which the derivative is taken. For the two-dimensional case we have the horizontal direction, the vertical direction, or an arbitrary direction which can be considered as a combination of the two. If we use hₓ to denote a horizontal derivative filter (matrix), h_{y} to denote a vertical derivative filter (matrix), and h_{θ}, to denote the arbitrary angle derivative filter (matrix), then:

[h_{θ}]=cosθ·[hₓ]+sinθ[h_{y}]. Eq. 18

Gradient Filters

It is also possible to generate a vector derivative description as the gradient, ∇a[m, n], of an image:

$$▽ a = \frac{\partial a}{\partial x} {\vec{i}}_{x} + \frac{\partial a}{\partial y} {\vec{i}}_{y} = ( {h}_{x} ⊗ a ) {\vec{i}}_{x} + ( {h}_{y} ⊗ a ) {\vec{i}}_{y} \qquad Eq . 19$$

where, \vec{i}ₓ and \vec{i}_{y} are unit vectors in the horizontal and vertical direction, respectively.

This leads to two descriptions:

Gradient magnitude—|∇a|={square root over ((hₓx)}a)²+(h_{y}\mathring{x}a)²

and

Gradient direction—φ(∇a)=arctan {(h_{y}\mathring{x}a)/(hₓ\mathring{x}a)}

The gradient magnitude may be approximated by:

Approx. Gradient magnitude—|∇a|≅|hₓ\mathring{x}a|+h_{y}\mathring{x}a|

The final results of these calculations depend strongly on the choices of hₓ and h_{y}. A number of possible choices for (hₓ, h_{y}) will now be described.

Basic Derivative Filters

These filters are specified by:

i) [hₓ]=[h_{y}]^{t}=[1 −1]

ii) [hₓ]=[h_{y}]^{t}=[1 0 −1]

where “^{t}” denotes matrix transpose. These two filters differ significantly in their Fourier magnitude and Fourier phase characteristics. For the frequency range 0<=Ω<=π, these are given by:

$$\begin{matrix}i ) [ h ] = [ \begin{matrix}1 & - 1\end{matrix} ] {↔}^{F} \vert H ( Ω ) \vert = 2 \vert sin ( \frac{Ω}{2} ) \vert ; ϕ ( Ω ) = ( π - Ω ) / 2 \\ ii ) [ h ] = [ \begin{matrix}1 & 0 & - 1\end{matrix} ] {↔}^{F} \vert H ( Ω ) \vert = 2 \vert sin ( Ω ) \vert ; ϕ ( Ω ) = \frac{π}{2}\end{matrix}$$

The second form (ii) gives suppression of high frequency terms (Ω˜π) while the first form (i) does not. The first form leads to a phase shift; the second form does not.

Prewitt-Gradient Filters

These filters are specified by:

$$\begin{matrix}[ {h}_{x} ] = \frac{1}{3} [ \begin{matrix}1 & 0 & - 1 \\ 1 & 0 & - 1 \\ 1 & 0 & - 1\end{matrix} ] = \frac{1}{3} [ \begin{matrix}1 \\ 1 \\ 1\end{matrix} ] \cdot [ \begin{matrix}1 & 0 & - 1 ] ,\end{matrix} \\ [ {h}_{y} ] = \frac{1}{3} [ \begin{matrix}1 & 1 & 1 \\ 0 & 0 & 0 \\ - 1 & - 1 & - 1\end{matrix} ] = \frac{1}{3} [ \begin{matrix}1 \\ 0 \\ - 1\end{matrix} ] \cdot [ \begin{matrix}1 & 1 & 1 ] .\end{matrix}\end{matrix}$$

Both hₓ and h_{y} are separable. Beyond the computational implications are the implications for the analysis of the filter. Each filter takes the derivative in one direction using Eq. ii and smoothes in the orthogonal direction using a one-dimensional version of a uniform filter as described above.

Sobel-Gradient Filters

These filters are specified by:

$$\begin{matrix}[ {h}_{x} ] = \frac{1}{4} [ \begin{matrix}1 & 0 & - 1 \\ 2 & 0 & - 2 \\ 1 & 0 & - 1\end{matrix} ] = \frac{1}{4} [ \begin{matrix}1 \\ 2 \\ 1\end{matrix} ] \cdot [ \begin{matrix}1 & 0 & - 1 ] ,\end{matrix} \\ [ {h}_{y} ] = \frac{1}{4} [ \begin{matrix}1 & 2 & 1 \\ 0 & 0 & 0 \\ - 1 & - 2 & - 1\end{matrix} ] = \frac{1}{4} [ \begin{matrix}1 \\ 0 \\ - 1\end{matrix} ] \cdot [ \begin{matrix}1 & 2 & 1 ] .\end{matrix}\end{matrix}$$

Again, hₓ and h_{y} are separable. Each filter takes the derivative in one direction using Eq. ii and smoothes in the orthogonal direction using a one-dimensional version of a triangular filter as described above.

Alternative-Gradient Filters

The variety of techniques available from one-dimensional signal processing for the design of digital filters offers powerful tools for designing one-dimensional versions of hₓ and h_{y}. Using the Parks-McClellan filter design algorithm, for example, we can choose the frequency bands where we want the derivative to be taken and the frequency bands where we want the noise to be suppressed. The algorithm will then produce a real, odd filter with a minimum length that meets the specifications.

As an example, if we want a filter that has derivative characteristics in a passband (with weight 1.0) in the frequency range 0.0<=Ω<=0.3π and a stopband (with weight 3.0) in the range 0.32π<=Ω<=π, then the algorithm produces the following optimized seven sample filter:

$$[ {h}_{x} ] = {[ {h}_{y} ]}^{t} = \frac{1}{16348} [ \begin{matrix}- 3571 & 8212 & - 15580 & 0 & 15580 & - 8212 & 3571 ]\end{matrix}$$

The gradient can then be calculated as in Eq. 19.

Gaussian-Gradient Filters

In modern digital-image processing one of the most common techniques is to use a Gaussian filter to accomplish the required smoothing and one of the derivatives listed in Eq. 19. Thus, we might first apply the recursive Gaussian in Eqs. 14-17 followed by Eq. ii to achieve the desired, smoothed derivative filters hₓ and h_{y}. Further, for computational efficiency, we can combine these two steps as:

$$w [ n ] = ( \frac{B}{2} ) ( a [ n + 1 ] - a [ n - 1 ] ) + ( {b}_{1} w [ n - 1 ] + {b}_{2} w [ n - 2 ] + {b}_{3} w [ n - 3 ] ) / {b}_{0} ,$$

c[n]=Bw[n]+(b₁c[n+1]+b₂c[n+2]+b₃c[n+3])/b₀

where, the various coefficients are defined in Eq. 15. The first (forward) equation is applied from n=0 up to n=N−1 while the second (backward) equation is applied from n=N−1 down to n=0.

The magnitude gradient takes on large values where there are strong edges in the image. Appropriate choice of σ in the Gaussian-based derivative or gradient permits computation of virtually any of the other forms—simple, Prewitt, Sobel, etc. In that sense, the Gaussian derivative represents a superset of derivative filters.

Second Derivatives

It is, of course, possible to compute higher-order derivatives of functions of two variables. In image processing, as we shall see second derivatives or Laplacian play an important role. The Laplacian is defined as:

$${▽}^{2} a = \frac{{\partial }^{2} a}{\partial {x}^{2}} + \frac{{\partial }^{2} a}{\partial {y}^{2}} = ( {h}_{2 x} ⊗ a ) + ( {h}_{2 y} ⊗ a ) \qquad Eq . 20$$

where h₂ₓ and h_{2y} are second derivative filters. In the frequency domain we have for the Laplacian filter:

$${▽}^{2} a {↔}^{F} - ( {u}^{2} + {v}^{2} ) A ( u , v ) .$$

The transfer function of a Laplacian corresponds to a parabola (u,v)=−(u²+v²).

Basic Second-Derivative Filter

This filter is specified by:

[h₂ₓ]=[h_{2y}]^{t}=[1 2 −1]

and the frequency spectrum of this filter, in each direction, is given by:

H(Ω)=F{1 −2 1}=−2(1−cos Ω)

over the frequency range −π<=Ω<=π. The two, one-dimensional filters can be used in the manner suggested by i and ii or combined into one, two-dimensional filter as:

$$h = [ \begin{matrix}0 & 1 & 0 \\ 1 & - 4 & 1 \\ 0 & 1 & 0\end{matrix} ]$$

and used as in Eq. 19.

Frequency-Domain Laplacian

This filter is the implementation of the general recipe given in Eq. 20 and for the Laplacian filter takes the form:

c[m,n]=F⁻¹{−(Ω²+Ψ²)A(Ω, Ψ)}.

Gaussian Second Derivative Filter

This is the straightforward extension of the Gaussian first-derivative filter described above and can be applied independently in each dimension. We first apply Gaussian smoothing with a chosen on the basis of the problem specification. We then apply the desired second derivative filter. Again there is the choice among the various Gaussian smoothing algorithms.

For efficiency, we can use the recursive implementation and combine the two steps—smoothing and derivative operation—as follows:

w[n]=B(a[n+1]−a[n−1])+(b₁w[n−1]+b₂w[n−2]+b₃w[n−3])/b₀,

c[n]=B(w[n+1]−w[n])+(b₁c[n+1]+b₂c[n+2]+b₃c[n+3])/b₀

where, the various coefficients are defined in Eq. 15. Again, the first (forward) equation is applied from n=0 up to n=N−1 while the second (backward) equation is applied from n=N−1 down to n=0.

Alternative-Laplacian Filters

Again one-dimensional digital filter design techniques offer us powerful methods to create filters that are optimized for a specific problem. Using the Parks-McClellan design algorithm, we can choose the frequency bands where we want the second derivative to be taken and the frequency bands where we want the noise to be suppressed. The algorithm will then produce a real, even filter with a minimum length that meets the specifications.

As an example, if we want a filter that has second derivative characteristics in a passband (with weight 1.0) in the frequency range 0.0<=Ω<=0.3π and a stopband (with weight 3.0) in the range 0.32π<=Ω<=π, then the algorithm produces the following optimized seven sample filter:

$$[ {h}_{x} ] = {[ {h}_{y} ]}^{t} = \frac{1}{11043} [ \begin{matrix}- 3448 & 10145 & 1495 & - 16383 & 1495 & 10145 & - 3448\end{matrix} ]$$

The Laplacian can then be calculated as in Eq. 19.

Second-Derivative-In-The-Gradient-Direction Filter

A filter that is especially useful in edge finding and object measurement is the Second-Derivative-in-the-Gradient-Direction (SDGD) filter. This filter uses five partial derivatives:

$$\begin{matrix}{A}_{xx} = \frac{{\partial }^{2} a}{\partial {x}^{2}} & {A}_{xy} = \frac{{\partial }^{2} a}{\partial x \partial y} & {A}_{x} = \frac{\partial a}{\partial x} \\ {A}_{yx} = \frac{{\partial }^{2} a}{\partial x \partial y} & {A}_{yy} = \frac{{\partial }^{2} a}{\partial {y}^{2}} & {A}_{y} = \frac{\partial a}{\partial y}\end{matrix}$$

Note that A_{xy}=A_{yx}, which accounts for the five derivatives.

This SDGD combines the different partial derivatives as follows:

h₁ₓ[1 0 −1]h₁ₓ\mathring{x}h₁ₓ=h₂ₓ=[1 0 −2 0 1].

As one might expect, the large number of derivatives involved in this filter implies that noise suppression is important and that Gaussian derivative filters—both first and second order—are highly recommended if not required. It is also necessary that the first and second derivative filters have essentially the same passbands and stopbands. This means that if the first derivative filter h₁ₓ is given by [1 0 −1] (Eq. ii) then the second derivative filter should be given by h₁ₓ\mathring{x}h₁ₓ=h₂ₓ=[1 0 −2 0 1].

Other Filters

An infinite number of filters, both linear and non-linear, are possible for image processing. It is therefore impossible to describe more than the basic types in this section. The description of others can be found be in the reference literature, as well as in applications literature. It is important to use a small consistent set of test images that are relevant to the application area to understand the effect of a given filter or class of filters. The effect of filters on images can be frequently understood by the use of images that have pronounced regions of varying sizes to visualize the effect on edges or by the use of test patterns such as sinusoidal sweeps to visualize the effects in the frequency domain.

Morphology-Based Operations

An image is defined as an (amplitude) function of two, real (coordinate) variables a(x,y) or two, discrete variables a[m,n]. An alternative definition of an image can be based on the notion that an image consists of a set (or collection) of either continuous or discrete coordinates. In a sense, the set corresponds to the points or pixels that belong to the objects in the image. For the moment, consider the pixel values to be binary as discussed above. Further, the discussion shall be restricted to discrete space.

An object A consists of those pixels a that share some common property:

ObjectA={a|property(a)==TRUE}

As an example, object B consists of {[0,0], [1,0], [0,1]}.

The background of A is given by A^{c} (the complement of A) which is defined as those elements that are not in A:

BackgroundA^{c}={a|a∉A}

We now observe that if an object A is defined on the basis of C-connectivity (C=4, 6, or 8) then the background A^{c} has a connectivity given by 12−C.

Fundamental Definitions

The fundamental operations associated with an object are the standard set operations union, intersection, and complement {∪, ∩, ^{c}} plus translation:

1. Translation

Given a vector, x and a set A, the translation, A+x, is defined as:

A+x={a+x|a∈A} Eq. 21

Note that, since we are dealing with a digital image composed of pixels at integer coordinate positions (Z²), this implies restrictions on the allowable translation vectors x.

The basic Minkowski set operations—addition and subtraction—can now be defined. First we note that the individual elements that comprise B are not only pixels but also vectors as they have a clear coordinate position with respect to [0,0]. Given two sets A and B:

$$\begin{matrix}Minkowski addition \text{-} A ⊕ B = {⋂}_{β ∈ β} ( A + B ) & Eq . 22 \\ Minkowski subtraction \text{-} A - B = {⋂}_{β ∈ β} ( A + B ) & Eq . 23\end{matrix}$$

Dilation and Erosion

From these two Minkowski operations we define the fundamental mathematical morphology operations dilation and erosion:

$$\begin{matrix}Dilation \text{-} D ( A , B ) = A ⊕ B = {⋃}_{β ∈ β} ( A + β ) & Eq . 24 \\ Erosion \text{-} E ( A , B ) = A - ( - B ) = {⋂}_{β ∈ β} ( a - β ) \\ where - B = \{ - β \vert β ∈ B \} . & Eq . 25\end{matrix}$$

While either set A or B can be thought of as an “image,” A is usually considered as the image and B is called a structuring element. The structuring element is to mathematical morphology what the convolution kernel is to linear filter theory. Dilation, in general, causes objects to dilate or grow in size; erosion causes objects to shrink. The amount and the way that they grow or shrink depend upon the choice of the structuring element. Dilating or eroding without specifying the structural element makes no more sense than trying to lowpass filter an image without specifying the filter. The two most common structuring elements (given a Cartesian grid) are the 4-connected and 8-connected sets, N₄ and N₈. The 4-connected structuring element consists of 4 pixels in the shape of a cross. The 8-connected structuring element consists of 8 pixels in a 3×3 square.

The dilation and erosion functions have the following properties:

Commutative—D(A, B)=A⊕B=B⊕A=D(B, A)

Non-Commutative—E(A, B)≠E(B, A)

Associative—A⊕(B⊕C)=(A⊕B)⊕C

Translation Invariance—A⊕(B+x)=(A⊕B)+x

Duality—D^{C}(A, B)=E(A^{C},−B)

E^{C}(A, B)=D(A^{C},−B)

With A as an object and A^{c} as the background, the dilation of an object is equivalent to the erosion of the background. Likewise, the erosion of the object is equivalent to the dilation of the background.

Except for special cases:

Non-Inverses—D(E(A, B), B)≠A≠E(D(A, B), B)

Erosion has the following translation property:

Translation Invariance—A−(B+x)=(A+x)−B=(A−B)+x

Dilation and erosion have the following important properties. For any arbitrary structuring element B and two image objects A₁ and A₂ such that A₁ ⊂A₂ (A₁ is a proper subset of A₂):

Increasing in A—D(A₁, B)⊂D(A₂, B)

E(A₁, B)⊂E(A₂, B)

For two structuring elements B₁ and B₂ such that B₁⊂B₂:

Decreasing in B—E(A, B₁)⊃E(A, B₂)

The decomposition theorems below make it possible to find efficient implementations for morphological filters.

Dilation—A⊕(B∪C)∪(A⊕C)=(B∪C)⊕A

Erosion—A−(B∪C)=(A−B)∩(A−C)

Erosion—(A−B)−C=A−(B⊕C)

$$Multiple Dilations \text{-} nB = \underbrace{( B ⊕ B ⊕ B ⊕ … ⊕ B )}_{ntimes}$$

An important decomposition theorem is due to Vincent. A convex set (in R²) is one for which the straight line joining any two points in the set consists of points that are also in the set. Care must obviously be taken when applying this definition to discrete pixels as the concept of a “straight line” must be interpreted appropriately in Z². A set is bounded if each of its elements has a finite magnitude, in this case distance to the origin of the coordinate system. A set is symmetric if B=−B. The sets N₄ and N₈ are examples of convex, bounded, symmetric sets.

Vincent's theorem, when applied to an image consisting of discrete pixels, states that for a bounded, symmetric structuring element B that contains no holes and contains its own center [0,0]∈B:

D(A, B)=A⊕B=A∪(∂A⊕B)

where, ∂A is the contour of the object. That is, ∂A is the set of pixels that have a background pixel as a neighbor. The implication of this theorem is that it is not necessary to process all the pixels in an object in order to compute a dilation or an erosion. We only have to process the boundary pixels. This also holds for all operations that can be derived from dilations and erosions. The processing of boundary pixels instead of object pixels means that, except for pathological images, computational complexity can be reduced from O(N²) to O(N) for an N×N image. A number of “fast” algorithms can be found in the literature that are based on this result. The simplest dilation and erosion algorithms are frequently described as follows.

Dilation

Take each binary object pixel (with value “1”) and set all background pixels (with value “0”) that are C-connected to that object pixel to the value “1.”

Erosion

Take each binary object pixel (with value “1”) that is C-connected to a background pixel and set the object pixel value to “0.” Comparison of these two procedures where B=N_{C=4} or N_{C=8} shows that they are equivalent to the formal definitions for dilation and erosion.

Boolean Convolution

An arbitrary binary image object (or structuring element) A can be represented as:

$$A ↔ {\sum }_{k = - ∞}^{+ ∞} {\sum }_{j = - ∞}^{+ ∞} a [ j , k ] \cdot δ [ m - j , n - k ]$$

where Σ and * are the Boolean operations OR and AND as defined above and a[j,k] is a characteristic function that takes on the Boolean values “1” and “0” as follows:

$$\begin{matrix}a [ j , k ] = 1 & a ∈ A \\ = 0 & a ∉ A\end{matrix}$$

and δ[m,n] is a Boolean version of the Dirac-delta function that takes on the Boolean values “1” and “0” as follows:

$$\begin{matrix}δ [ j , k ] = 1 & j = k = 0 \\ = 0 & otherwise\end{matrix}$$

Dilation for binary images can therefore be written as:

$$D ( A , B ) = {\sum }_{k = - ∞}^{+ ∞} {\sum }_{j = -}^{+ ∞} a [ j , k ] \cdot b [ m - j , n - k ] = a ⊗ b$$

which, because Boolean OR and AND are commutative, can also be written as

$$D ( A , B ) = {\sum }_{k = - ∞}^{+ ∞} {\sum }_{j = -}^{+ ∞} a [ m - j , n - k ] + b [ j , k ] = b ⊗ a = D ( B , A )$$

Using De Morgan's theorem:

\overline{(a+b)}=\overline{a}·\overline{b} and \overline{(a·b)}=\overline{a}+\overline{b}

erosion can be written as:

$$E ( A , B ) = {\prod }_{k = - ∞}^{+ ∞} {\prod }_{j = - ∞}^{+ ∞} ( a [ m - j , n - k ] + \overline{b} [ - j , - k ] )$$

Thus, dilation and erosion on binary images can be viewed as a form of convolution over a Boolean algebra.

When convolution is employed, an appropriate choice of the boundary conditions for an image is essential. Dilation and erosion—being a Boolean convolution—are no exception. The two most common choices are that either everything outside the binary image is “0” or everything outside the binary image is “1.”

Opening and Closing

We can combine dilation and erosion to build two important higher order operations:

Opening—O(A, B)=A∘B=D(E(A, B), B)

Closing—C(A, B)=A∘B=E(D(A,−B),−B)

The opening and closing have the following properties:

Duality—C^{C}(A, B)=O(A^{C}, B)

O^{C}(A, B)=C(A^{C}, B)

Translation—O(A+x, B)=O(A, B+x)

C(A+x, B)C(A, B+x)

For the opening with structuring element B and images A, A₁, and A₂, where A₁ is a sub-image of A₂ (A₁⊂A₂):

Anti-extensivity—O(A, B)⊂A

Increasing monotonicity—O(A₁, B)⊂O(A₂, B)

Idempotence—O(O(A, B), B)=O(A, B)

For the closing with structuring element B and images A, A₁, and A₂, where A₁ is a sub-image of A₂ (A₁⊂A₂):

Extensivity—A⊂C(A, B)

Increasing monotonicity—C(A₁, B)⊂C(A₂, B)

Idempotence—C(C(A, B), B)=C(A, B)

The properties given above are so important to mathematical morphology that they can be considered as the reason for defining erosion with −B instead of B.

Hit and Miss Operation

The hit-or-miss operator was defined by Serra. Here, it will be referred to as the hit-and-miss operator and define it as follows. Given an image, A and two structuring elements, B₁ and B₂, the set definition and Boolean definition are:

$$\begin{matrix}HitMiss ( A , {B}_{1} , {B}_{2} ) = E ( A , {B}_{1} ) ⋂ {E}^{C} ( {A}^{C} , {B}_{2} ) \\ = E ( A , {B}_{1} ) \cdot \overline{E} ( \overline{\overline{A , {B}_{2}}} ) \\ = A ( A , {B}_{1} ) - E ( \overline{A} ) , {B}_{2}\end{matrix}$$

where B₁ and B₂ are bounded, disjoint structuring elements. Two sets are disjoint if B₁∩B₂=Ø, the empty set. In an important sense the hit-and-miss operator is the morphological equivalent of template matching, a well-known technique for matching patterns based upon cross-correlation. Here, we have a template, B₁ for the object and a template, B₂ for the background.

The opening operation can separate objects that are connected in a binary image. The closing operation can fill in small holes. Both operations generate a certain amount of smoothing on an object contour given a “smooth” structuring element. The opening smoothes from the inside of the object contour and the closing smoothes from the outside of the object contour. The hit-and-miss example has found the 4-connected contour pixels. An alternative method to find the contour is simply to use the relation:

4-connectedcontour—δA=A−E(A, N₈)

or

8-connectedcontour—δA=A−E(A, N₄)

Skeleton

The informal definition of a skeleton is a line representation of an object that is:

i) one-pixel thick,

ii) through the “middle” of the object, and,

iii) preserves the topology of the object.

These are not always realizable.

For example, it is not possible to generate a line that is one pixel thick and in the center of an object, while generating a path that reflects the simplicity of the object. It is not possible to remove a pixel from the 8-connected object and simultaneously preserve the topology—the notion of connectedness—of the object. Nevertheless, there are a variety of techniques that attempt to achieve this goal and to produce a skeleton.

A basic formulation is based on the work of Lantuéjoul. The skeleton subset Sₖ(A) is defined as:

Sₖ(A)=E(A, kB)−[E(A, kB)∘B] k=0, 1, . . . K

where, K is the largest value of k before the set Sₖ(A) becomes empty. The structuring element B is chosen (in Z²) to approximate a circular disc, that is, convex, bounded, and symmetric. The skeleton is then the union of the skeleton subsets:

$$S ( A ) = {{⋃}_{k = 0}}^{K} {S}_{k} ( A )$$

An elegant side effect of this formulation is that the original object can be reconstructed given knowledge of the skeleton subsets Sₖ(A), the structuring element B, and K:

$$A = {{⋃}^{K}}_{k = 0} ( {S}_{k} ( A ) ⊕ kB )$$

This formulation for the skeleton, however, does not preserve the topology, a requirement described above.

An alternative point-of-view is to implement a thinning, or erosion that reduces the thickness of an object without permitting it to vanish. A general thinning algorithm is based on the hit-and-miss operation:

Thin(A, B₁, B₂ )=A−HitMiss(A, B₁, B₂)

Depending on the choice of B₁ and B₂, a large variety of thinning algorithms—and through repeated application “skeletonizing” algorithms—can be implemented. A quite practical implementation can be described in another way. If we restrict ourselves to a 3×3 neighborhood, similar to the structuring element B=N₈, then we can view the thinning operation as a window that repeatedly scans over the (binary) image and sets the center pixel to “0” under certain conditions. The center pixel is not changed to “0” if and only if:

i) an isolated pixel is found,

ii) removing a pixel would change the connectivity,

iii) removing a pixel would shorten a line.

As pixels are (potentially) removed in each iteration, the process is called a conditional erosion. In general, all possible rotations and variations have to be checked. As there are only 512 possible combinations for a 3×3 window on a binary image, this can be done easily with the use of a lookup table.

If only condition (i) is used then each object will be reduced to a single pixel. This is useful if we wish to count the number of objects in an image. If only condition (ii) is used, then holes in the objects will be found. If conditions (i+ii) are used, each object will be reduced to either a single pixel if it does not contain a hole or to closed rings if it does contain holes. If conditions (i+ii+iii) are used, then the “complete skeleton” will be generated.

Propagation

It is convenient to be able to reconstruct an image that has “survived” several erosions or to fill an object that is defined, for example, by a boundary. The formal mechanism for this has several names including region-filling, reconstruction, and propagation. The formal definition is given by the following algorithm. We start with a seed image S⁽⁰⁾, a mask image A, and a structuring element B. We then use dilations of S with structuring element B and masked by A in an iterative procedure as follows:

S^{(k)}=[S^{(k-1)}⊕B]∩A until S^{(k)}i =S^{(k-1)}

With each iteration the seed image grows (through dilation) but within the set (object) defined by A; S propagates to fill A. The most common choices for B are N₄ or N₈. Several remarks are central to the use of propagation. First, in a straightforward implementation, the computational costs are extremely high. Each iteration requires O(N²) operations for an N×N image and with the required number of iterations this can lead to a complexity of O(N³). Fortunately, a recursive implementation of the algorithm exists in which one or two passes through the image are usually sufficient, meaning a complexity of O(N²). Second, although not much attention has been paid to the issue of object/background connectivity until now, it is essential that the connectivity implied by B be matched to the connectivity associated with the boundary definition of A. Finally, as mentioned earlier, it is important to make the correct choice (“0” or “1”) for the boundary condition of the image. The choice depends upon the application.

Gray-Value Morphological Processing

The techniques of morphological filtering can be extended to gray-level images. To simplify matters we will restrict our presentation to structuring elements, B, that comprise a finite number of pixels and are convex and bounded. Now, however, the structuring element has gray values associated with every coordinate position, as does the image A.

Gray-level dilation, D_{G}(*), is given by:

$${D}_{G} ( A , B ) = {max}_{[ j , k ] ∈ B} \{ a [ m - j , n - k ] + b [ j , k ] \}$$

For a given output coordinate [m,n], the structuring element is summed with a shifted version of the image and the maximum encountered over all shifts within the J×K domain of B is used as the result. Should the shifting require values of the image A that are outside the M×N domain of A, then a decision must be made as to which model for image extension, as described above, should be used.

Gray-level erosion, E_{G}(*), is given by:

$${E}_{G} ( A , B ) = {min}_{[ j , k ] ∈ B} \{ a [ m + j , n + k ] - b [ j , k ] \}$$

The duality between gray-level erosion and gray-level dilation is somewhat more complex than in the binary case:

E_{G}(A, B)=−D_{G}(−Ã, B)

where “−Ã” means that a[j,k]−>−a[−j,−k].

The definitions of higher order operations such as gray-level opening and gray-level closing are:

O_{G}(A, B)=D_{G}(E_{G}(A, B), B)

O_{C}(A, B)=−O_{G}(−A,−B)

The important properties that were discussed earlier such as idempotence, translation invariance, increasing in A, and so forth are also applicable to gray-level morphological processing. In many situations the seeming complexity of gray-level morphological processing is significantly reduced through the use of symmetric-structuring elements where b[j,k]=b[−j,−k]. The most common of these is based on the use of B=constant=0. For this important case and using again the domain [j,k] B, the definitions above reduce to:

$$\begin{matrix}{D}_{G} ( A , B ) = {max}_{[ j , k ] ∈ B} \{ a [ m - j , n - k ] \} = {max}_{B} ( A ) \\ {E}_{G} ( A , B ) = {min}_{[ j , k ] ∈ B} \{ a [ m - j , n - k ] \} = {min}_{B} ( A ) \\ {O}_{G} ( A , B ) = {max}_{B} ( {min}_{B} ( A ) ) \\ {C}_{G} ( A , B ) = {min}_{B} ( {max}_{B} ( A ) )\end{matrix}$$

The remarkable conclusion is that the maximum filter and the minimum filter, introduced above, are gray-level dilation and gray-level erosion for the specific structuring element given by the shape of the filter window with the gray value “0” inside the window.

For a rectangular window, J×K, the two-dimensional maximum or minimum filter is separable into two, one-dimensional windows. Further, a one-dimensional maximum or minimum filter can be written in incremental form. This means that gray-level dilations and erosions have a computational complexity per pixel that is O(constant), that is, independent of J and K. (See also Table II.)

The operations defined above can be used to produce morphological algorithms for smoothing, gradient determination and a version of the Laplacian. All are constructed from the primitives for gray-level dilation and gray-level erosion and in all cases the maximum and minimum filters are taken over the domain [j,k]∈B.

Morphological Smoothing

This algorithm is based on the observation that a gray-level opening smoothes a gray-value image from above the brightness surface given by the function a[m,n] and the gray-level closing smoothes from below. We use a structuring element B as described above.

$$\begin{matrix}MorphSmooth ( A , B ) = {C}_{G} ( {O}_{G} ( A , B ) , B ) \\ = min ( max ( min ( A ) ) ) )\end{matrix}$$

Note that we have suppressed the notation for the structuring element B under the max and min operations to keep the notation simple.

Morphological Gradient

For linear filters, the gradient filter yields a vector representation. The version presented here generates a morphological estimate of the gradient magnitude:

$$\begin{matrix}Gradient ( A , B ) = \frac{1}{2} ( {D}_{G} ( A , B ) - {E}_{G} ( A , B ) ) \\ = \frac{1}{2} ( max ( A ) - min ( A ) )\end{matrix}$$

Morphological Laplacian

The morphologically-based Laplacian filter is defined by:

$$\begin{matrix}Laplacian ( A , B ) = \frac{1}{2} ( ( {D}_{G} ( A , B ) - {E}_{G} ( A , B ) ) ) \\ = \frac{1}{2} ( {D}_{G} ( A , B ) + {E}_{G} ( A , B ) - 2 A ) \\ = \frac{1}{2} ( max ( A ) + min ( A ) - 2 A )\end{matrix}$$

The image-processing algorithms and the background information required to apply them, as outlined above, is further illustrated in a tutorial entitled, “Image Processing Fundamentals” that may be found on the Internet at http://www.ph.tn.tudelft.nl/Courses/FIP/frames/fip.html.

A second set (i.e., an alternative set) of image-processing algorithms suitable for use in the image enhancer 300 of the IAES 10 are presented by Pitas, Ioannis in “Digital-Image Processing Algorithms and Applications,” (1^{st} ed. 1993), the entire contents of which is hereby incorporated by reference in its entirety.

As further illustrated in the functional-block diagram of FIG. 3, the image processor 330 may include an auto-adjust module 332. The auto-adjust module 332 contains image-analysis routines for characterizing those portions of a baseline image that immediately surround region “A” data 323 (i.e., an undesirable area). The auto-adjust module 332 is configured to analyze the proposed region “B” data 325 (i.e., the desirable version from another portion of the same digital image or a related image) and modify the image data in the proposed region “B” data 325 to generate a more pleasing composite-digital image. More particularly, the auto-adjust module modifications can include, but are not limited to, enhancing the composite digital image by correcting for sharpness, color, lightening underexposed digital images, darkening overexposed digital images, removing flash reflections, etc.

Preferably, the image enhancer 300 is configured to interface with a plurality of output devices 212, which render or convert the enhanced-image instance 500 into an operator-observable image. For example, the image enhancer 300 may send an enhanced-image instance 500 to a display monitor, which then converts the image into a format suitable for general viewing. Other output devices 212 may convert the enhanced-image instance 500 into appropriate formats for storage, faxing, printing, electronic mailing, etc.

It should be appreciated that once the enhanced-image instance 500 is available in buffers associated with other applications, it is no longer dependent upon the image enhancer 300 and can be processed externally. Once an enhanced image 500 has been stored on a networked device (e.g., remote general-purpose computer 18, data-storage device 16, etc.) the image may be available to operators with appropriate file access to the various storage and processing devices associated with the network 15.

The image enhancer 300 can be implemented in software, firmware, hardware, or a combination thereof. In this embodiment, the image enhancer 300 is implemented in software as an executable program. If implemented solely in hardware, as in an alternative embodiment, the image enhancer 300 can be implemented with any or a combination of the following technologies which are well known in the art: discrete-logic circuits, application-specific integrated circuits (ASICs), programmable-gate arrays (PGAs), field-programmable gate arrays (FPGAs), etc.

When the image enhancer 300 is implemented in software, as shown in FIG. 2, it should be noted that the image enhancer 300 can be stored on any computer-readable medium for use by or in connection with any computer related system or method. In the context of this document, a computer-readable medium is an electronic, magnetic, optical, or other physical device or means that can contain or store a computer program for use by, or in connection with a computer related system or method. The computer-readable medium can be, for example but not limited to, an electronic, magnetic, optical, electromagnetic, infrared, or semiconductor system, apparatus, device, or propagation medium.

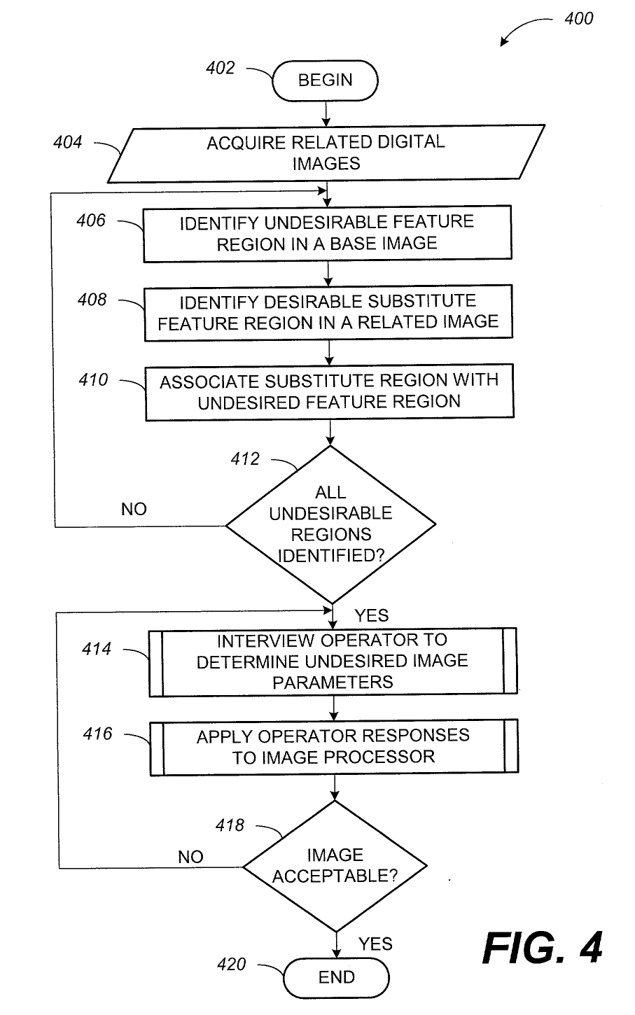

Reference is now directed to the flow chart of FIG. 4, which illustrates a method for enhancing digital images 400 that may be employed by an operator of the IAES 10 (FIG. 1) for modifying flawed digital images. The method 400 may begin with step 402 labeled, “BEGIN.” First, a set of related digital images are acquired as indicated in step 404. Related digital images are those images that contain common subject matter over at least a portion of each image. As previously described, under some circumstances, regions selected from the same digital image may suffice as related digital images.

Next, as indicated in step 406, an operator may identify an undesirable-feature region in a base image (e.g., image “A” data 322). The operator may identify the feature using conventional techniques, such as by locating vertices of a polygon surrounding the feature. More sophisticated image processors may be programmed to identify a selected feature such as a facial feature. These sophisticated image processors may be configured to recognize patterns, color, texture, shapes, etc. indicative of a particular feature such as a mouth, an eye, a nose, a hand.

Once the operator has identified a flawed or undesirable region of a digital image in step 406, the operator, or in the case where a sophisticated image processor is available, the image enhancer 300 may identify a potential-substitute region from a related digital image as indicated in step 408. As indicated in step 410, the IAES 10 may then associate the substitute region with the baseline image by arranging or inserting the information contained in the substitute region within the baseline image.

The IAES 10, having identified and replaced a first-flawed region in the baseline-digital image may then prompt an operator as illustrated in the query of step 412 as to whether all undesirable regions of the baseline image have been identified. When the response to the query of step 412 is negative, steps 406 through 412 may be repeated as necessary as illustrated by the flow-control arrow representing the negative-response branch. Otherwise, the IAES 10 may present an interim-modified image containing one or more substitute regions inserted to replace one or more associated undesired regions to the operator and initiate an operator interview as indicated in step 414. As further illustrated in step 416, the IAES 10 may then apply one or more modified image-processing parameters to an image processor to better match the substitute-image region to the surroundings of the baseline-digital image.

After applying the modified image-processing parameters to the substitute region an image-enhancer application program 300 within the IAES 10 may be programmed to prompt the operator as to whether the modified-composite image is acceptable to the operator as illustrated in the query of step 418. When the response to the query of step 418 is negative, steps 414 through 418 may be repeated as required until the operator is satisfied. It should be appreciated that since steps 414 through 418 are indicative of an iterative process that the various questions presented to the operator in each subsequent stage of the editing process may vary. In addition, it should be appreciated that the magnitude of subsequent image-processing parameter changes may also vary at subsequent stages. Otherwise, if the response to the query of step 418 is affirmative (i.e., the operator is satisfied with the result of the editing process) the method for digital-image enhancement 400 may terminate as indicated in step 420, labeled, “End.” The modified digital image may then be stored and/or communicated as previously described. It should be appreciated that steps 404 through 418 may be repeated as necessary to meet the image-processing desires of an operator of the IAES 10.

It is significant to note that process descriptions or blocks in the flow chart of FIG. 4 represent modules, segments, or portions of code which include one or more instructions for implementing specific steps in the method for enhancing digital images 400. Alternate implementations are included within the scope of the IAES 10 in which functions may be executed out of order from that shown or discussed, including concurrent execution or in reverse order, depending upon the functionality involved, as would be understood by those reasonably skilled in the art.

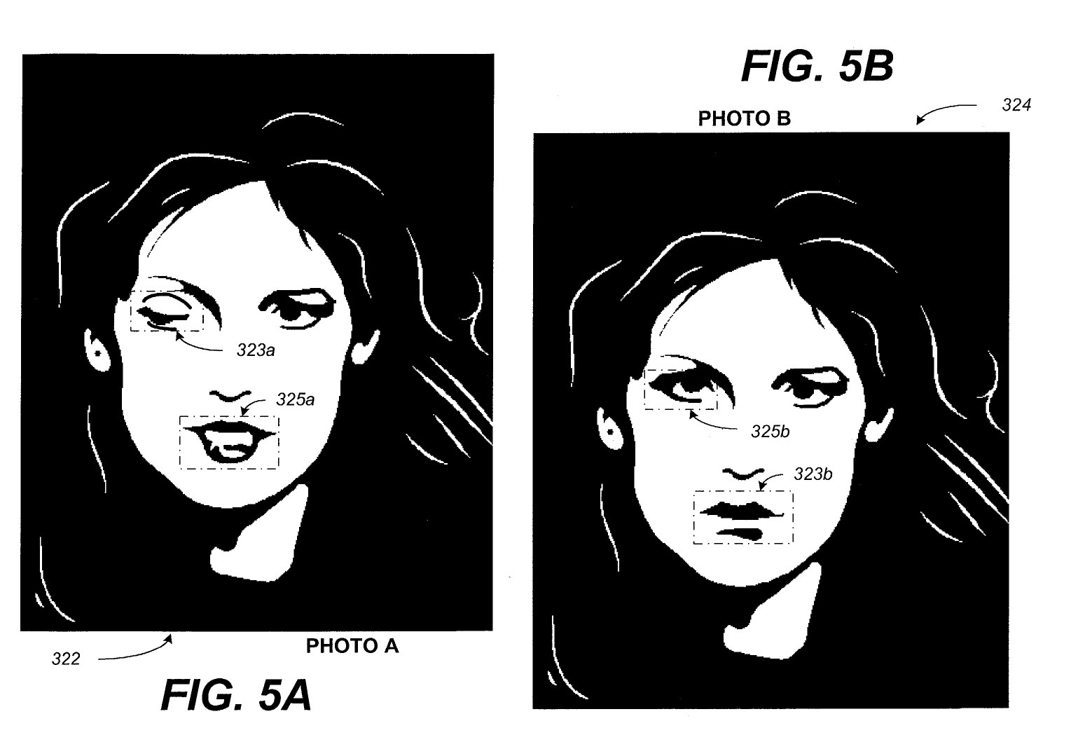

Reference is now directed to FIGS. 5A and 5B, which present schematic diagrams illustrating unmodified digital images. In this regard, FIG. 5A presents a photograph labeled, “Photo A” (e.g., image “A” data 322) of a woman winking at the photographer and a second photograph labeled, “Photo B” (e.g., image “B” data 324).

As is readily apparent, photographs A and B are roughly the same size, contain the same subject, and represent the subject in nearly identical poses. It is important to note that photographs A and B of FIGS. 5A and 5B are presented for simplicity of illustration only. An image enhancer 300 in accordance with the teachings of the present invention only requires that the subject matter of sub-regions of the images are related. Stated another way, the image enhancer 300 only requires that the undesirable region and the proposed substitute region illustrate similar feature(s) in substantially similar perspectives. For example, the subject in a first photograph may be a close-up of the woman of FIG. 5A, whereas a second photograph may include a host of people facing the photographer wherein one of the host in the photograph is the woman. Each of the examples noted above would contain the eyes and the mouth of the woman in the same perspective.

In accordance with the embodiments described above, an operator of the IAES 10 may acquire files containing photos A and B. The operator, through the image enhancer 300, may designate the woman's right eye as an undesirable feature (e.g., region “A” data 323a) by selecting opposing corners of sub-region identified by the dashed lines, or in the case of more sophisticated image editors communicating via user interface 310 that the subject's right eye is undesirable.

Despite the operator's identification of a flawed or undesirable region in image “A” data 322, the photograph has a number of pleasing regions. An exemplar “pleasing” region may be identified by an operator of the IAES 10 such as the woman's smile (e.g., region “B” data 325a). The proposed-substitute smile may be associated with the region “A” data 323b as may be identified by the operator within previously acquired image “B” data 324 illustrated in FIG. 5B. The photograph illustrated in FIG. 5B also contains a feature that is designated by the operator of the IAES 10 as undesirable. The undesirable feature selected by the operator as indicated by the dashed line surrounding the woman's smile (e.g., region “A” data 323b).

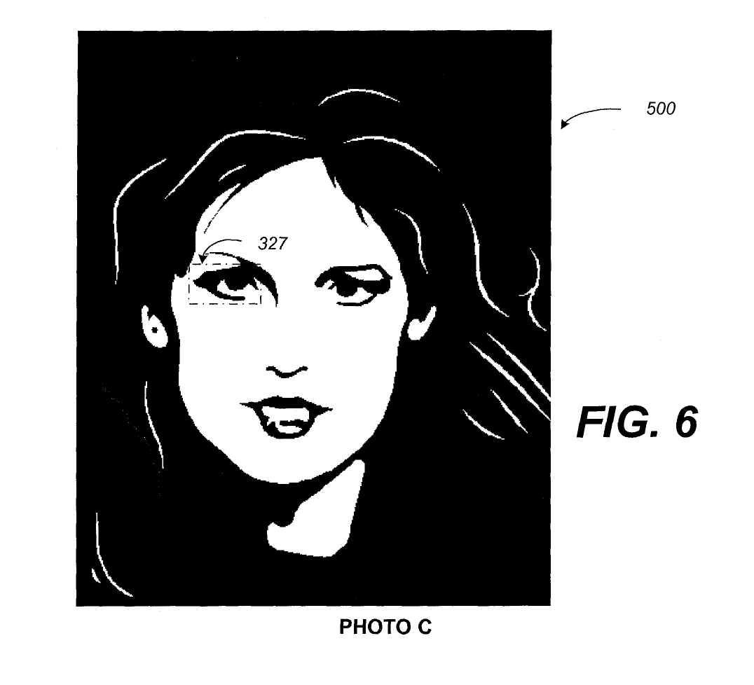

By associating the pleasing right eye of FIG. 5B with the undesired right eye of FIG. 5A and associating the pleasing smile of FIG. 5A with the undesired smile of FIG. 5B, an operator of the IAES 10 can direct the image enhancer to create a rough version of the image illustrated in FIG. 6 by directing the image processor 330 to insert the substitute regions over the associated undesirable regions. As illustrated in FIG. 6, enhanced image 500 contains all the baseline information of the image “A” data 322, as well as a modified region “B” data 327a (i.e., the open right eye). Other variations may include the baseline information of Photo B from FIG. 5B with the more pleasing smile from Photo A illustrated in FIG. 5A (not shown). As previously described in association with FIGS. 3 and 4, the composite image of FIG. 6 can then be modified via an iterative process until the operator can no longer detect that the substitute regions were not part of the underlying digital image.

It should be emphasized that the above embodiments of the image enhancer 300 are merely possible examples of implementations and are set forth for a clear understanding of the principles of the associated method for enhancing digital images. Variations and modifications may be made to the above embodiments of the image enhancer 300 without departing substantially from the principles thereof. All such modifications and variations are intended to be included within the scope of this disclosure and protected by the following claims.

Therefore, having thus described the invention, at least the following is claimed:

1. A digital-image-processing system, comprising:
means for acquiring related digital images including a first digital image and a second digital image wherein at least some portion of both the first and the second digital images contain information representing similar subject matter;
means for selecting an undesirable region of the first digital image;
means for selecting a desirable region of the second digital image;
means for generating a composite digital image comprising information from the first digital image and the desirable region of the second digital image; and
means for managing an interrogatory session to determine operator desired image information adjustments to generate an acceptable modified version of the composite image.

2. The processing system of claim 1, wherein the managing means includes means for adaptively presenting questions to an operator of the processing system.

3. The processing system of claim 2, wherein the presenting means is responsive to operator responses to queries regarding perceived differences between the first digital image and the desirable region of the second digital image.

4. The processing system of claim 1, further comprising:
means for enhancing the composite digital image responsive to image information derived from the first digital image.

5. The processing system of claim 4, wherein the enhancing means includes means for automatically adjusting the composite digital image responsive to results derived from an analysis of image information.

6. The processing system of claim 1, further comprising:
means for enhancing the composite digital image responsive to image information derived from the second digital image.

7. The processing system of claim 6, wherein the enhancing means includes means for automatically adjusting the composite digital image responsive to results derived from an analysis of image information.

8. A digital-image processing method, comprising the steps of:
receiving related digital-image information;
identifying an undesirable feature within the digital-image information;
associating a desired feature within the digital-image information with the undesirable feature;
replacing the undesirable feature with the desirable feature; and
adjusting the image information responsible for generating the desirable feature to produce a modified digital image.

9. The digital-image processing method of claim 8, wherein adjusting comprises an automated modification of the image information responsible for generating the desired feature responsive to results derived from an analysis of the remaining image information in the modified digital image.

10. The digital-image processing method of claim 8, wherein adjusting comprises an automated modification of the image information responsible for generating those portions of the modified digital image other than the desired feature responsive to results derived from an analysis of the image information responsible for generating the desired feature.

11. The digital-image processing method of claim 8, further comprising the steps of:
interrogating an operator of the processing system as to perceived differences between the desirable feature and the remaining digital-image information in the modified digital image; and
processing the desirable feature image information in accordance with operator responses.

12. The digital-image processing method of claim 11, wherein the steps of interrogating and processing are repeated until the operator deems the modified digital image acceptable.

13. The digital-image processing method of claim 12, wherein individual questions in a repeated interrogating step are adapted in response to a reply received from the operator of the processing system.

14. A digital-image-processing system, comprising:
a user-interface operable to receive a plurality of commands from an operator of the image-processing system via at least one input device, the user interface configured to identify a flawed region of a first digital image and a substitute region containing like subject matter to that contained in the flawed region from a second digital image;
a data manager communicatively coupled to the user interface configured to receive image information associated with the first digital image and the substitute region; and
an image processor coupled to the data manager configured to receive the image information and generate a composite image comprising the first digital image and the substitute region wherein the image processor is responsive to an interactive interview process.

15. The digital-image-processing system of claim 14, wherein the image processor comprises image-adjustment logic configured to analyze image information associated with the first digital image and the substitute region.

16. The digital-image-processing system of claim 15, wherein the image-adjustment logic modifies the image information responsible for generating the substitute region.

17. A computer-readable medium having a program for enhancing digital images, comprising:
logic for acquiring digital-image information;
logic for identifying an undesirable feature generated in response to the image information;
logic for associating a substitute feature with the identified undesirable feature;
logic for replacing the undesirable feature with the substitute feature; and
logic for presenting a question to an operator of an image-processing system to determine an image-processing solution that addresses what an operator perceives as a difference between the substitute feature and the digital image.

18. The computer-readable medium of claim 17, wherein the logic for presenting adaptively presents a question responsive to an operator's answer.

19. The computer-readable medium of claim 17, further comprising:
logic for modifying the digital-image information responsible for generating the substitute feature responsive to results derived from an analysis of the remaining image information in the modified digital image.

20. The computer-readable medium of claim 19, wherein the analysis comprises performing a statistical analysis on at least a portion of the image information responsible for generating those portions of the modified digital image adjacent to the substitute feature.
